(19) United States
(12) Patent Application Publication
(10) Pub. No.: US 2007/0276710 A1
(43) Pub. Date: Nov. 29, 2007

(54) System and Method for Selecting a Service Provider

(76) Inventors: Douglas Robert Hudgeon, New South Wales (AU); Derek Brand, New South Wales (AU); Marie Brand, New South Wales (AU)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/580,785

(22) PCT Filed: Nov. 24, 2004
(86) PCT No.: PCT/AU04/01631

§ 371 Date: Apr. 5, 2007

(30) Foreign Application Priority Data
Nov. 24, 2003 (AU) 2003906465

(51) Int. Cl. G06F 9/44

(52) U.S. Cl. 705/7

(57) ABSTRACT

There is disclosed a method and system for selecting a service provider to perform a particular service based on historical expectation differential data. The expectation differential data is preferably derived from the service provider's actual performance and a performance expectation. Methods of determining and varying expectations are also disclosed.

### FIELD OF THE INVENTION

The present invention relates to the procurement of services. In the illustrative embodiments the invention provides a system and method for allowing a service user to quantify and compare the desirability and/or performance of competing service providers, and to select a service provider to perform a particular service.

### BACKGROUND OF THE INVENTION

Potential purchasers of goods are often able to choose the product most appropriate to their needs by examining the product and assessing the quality of its construction and its suitability to the purchaser's needs. Usually, the price of the goods is known and therefore the purchaser may be able to base their purchase decision on a cost/benefit analysis of the product.

In contrast to goods, potential users of a service generally do not have the same level of information available to them on which to base their selection of a service provider. Therefore the process of ascertaining which service provider is the most appropriate, efficient and/or cost effective provider to perform a job can be a complex, time consuming and inexact process.

International patent application PCT/AU01/00660 to the applicant proposes a system and method for facilitating the selection of a service provider to perform a job. The system described therein uses the current rates charged by each service provider to estimate a cost effectiveness ranking for each service provider and allows the buyer to select a service provider based on this information.

PCT/AU03/00636, also to the applicant (the contents of which are herein incorporated by reference), proposes a system and method for facilitating the selection of a service provider that uses the previous invoiced amounts charged by each service provider to rank the providers by historical cost, and optionally uses historical qualitative assessments of the performance of each service provider to rank service providers by quality, and allows the buyer to select a service provider based on this information.

It has been found by the present inventors that the system disclosed in PCT/AU03/00636 has a number of disadvantages in certain circumstances. For example, PCT/AU03/00636 teaches that the desirability of service provider can be assessed on the basis of the actual historical costs charged by service providers and the details of the respective services requested by the service buyer. However this system cannot take into account changing circumstances that may arise during the course of a job.

Moreover, this system cannot be used to adequately compare service providers in relation to a job of a different type to the jobs for which historical data has been captured.

### SUMMARY OF THE INVENTION

It has been discovered that the determination of service providers' performance can effectively be made, wholly or in part, by assessing how well they have historically performed when measured against expectations and need not be judged by reference to their past performance on cost and quality of service using absolute measures such as total price per job, or per service element.

Thus, in a preferred embodiment the present invention provides a method (and system) which can be used by an individual or organisation wishing to select a supplier from a group of suppliers to perform a service, with or without the provision of associated goods. The preferred embodiment of the present invention provides a method and system for achieving an efficient marketplace between a group of sellers and at least one buyer, where the buyer or buyers repeatedly purchase products or services from the sellers.

In broad concept the present invention provides a method of selecting a service provider to perform a particular service based on historical expectation differential data. The expectation differential data is preferably derived from the service provider's actual performance and a performance expectation. A service provider's performance can be compared in respect of one or more service criteria indicative of service provider performance in respect of a particular facet of a service.

The present invention is based on the insight that an efficient marketplace can be encouraged if suppliers of services and/or goods know that their future work-flow is determined by a systematic comparison of how well they have met expectations in terms of both costs and quality in the past. Thus the present system and method encourages sellers of goods and/or services to provide a high quality of products and services within expected parameters in order to increase their likelihood of obtaining business in the future. Suppliers are also encouraged to make realistic estimations of costs and other performance measures relative to the instructions they are given by the buyer, and to take all foreseeable factors into account when setting expectations.

In a first aspect the present invention provides a computerised method of enabling the selection of a service provider for performing a service; said method including:

(a) processing a service enquiry for a particular service;

(b) retrieving historical expectation differential data associated with said service in respect of a plurality of service providers in response to said service enquiry;

(c) processing said historical expectation differential data, to arrive at comparable expectation differential data in respect of said plurality of service providers for enabling the selection of a service provider to perform the particular service;

(d) capturing expectation differential data relating to the provision of the particular service by the selected service provider, and

(e) updating the historical expectation differential data by incorporating said captured expectation differential data.

In a second aspect the present invention provides a computerised method of enabling the selection of a service provider for performing a service, said method including:

(a) compiling historical actual performance data and corresponding performance expectation data associated with the provision of at least one previous service by a plurality of service providers.

(b) processing said actual performance data and performance expectation data to arrive at comparable expectation differential data in respect of said service providers for enabling the selection of a service provider to perform the particular service;

(c) capturing actual performance data and performance expectation data relating to the provision of the particular service by the selected service provider; and

(d) updating the historical actual performance data and performance expectation data to incorporate said captured actual performance data and performance expectation data.

In a third aspect there is provided a computerised method of enabling the comparison of a service provider performing a service against at least one performance expectation, said method including:

(a) setting at least one initial performance expectation in relation to the service;

(b) capturing at least one amended performance expectation in relation to the service, in the event that at least one expectation variation criterion is met;

(c) determining at least one current performance expectation in relation to the service on the basis of one or more of, an initial performance expectation and one or more corresponding amended performance expectations on the basis of the variation criterion that was met at the time the amended performance expectation was captured;

(d) capturing actual performance data relating to the provision of the service by the service provider; and

(e) comparing the actual performance data against at least one current performance expectation.

In a fourth aspect there is provided a computer system to enable a buyer to select a service provider for performing a service, said system including:

an enquiry processing component configured to receive and process a service enquiry for a particular service from the buyer;

a database configured to store historical expectation differential data associated with said service in respect of a plurality of service providers;

a processor configured to retrieve and process said historical expectation differential data from said database in response to said query to arrive at comparable expectation differential data in respect of said service providers for enabling the buyer to select a service provider, on the basis of said comparable expectation differential data, to perform the particular service.

In a further aspect the present invention provides a computerised method of enabling a comparison of a performance of a service provider performing a service against at least one performance expectation, said method including:

(a) setting at least one initial performance expectation in relation to the service;

(b) receiving a request to amend the initial performance expectation in relation to the service;

(c) processing the request by either accepting, rejecting or modifying the received request;

(d) determining at least one current performance expectation in relation to the service on the basis of at least one initial performance expectation and the processed request; and

(e) comparing the performance of the service provider in relation to service to the least one current performance expectation.

In a further aspect the present invention also provides computer-readable medium having stored thereon executable instructions for causing a computer to perform a method as described herein. The present invention also provides a computer operating under the control of the abovementioned computer readable medium.

For example, using an embodiment of the present invention, if a buyer wishes to allocate an investigation job to a service provider and the job does not include surveillance as an element, but all of the historical data available relates to surveillance investigations, a comparison of service providers can still be made by comparing the actual historical costs of each provider to the expected historical cost for each provider to derive comparable expectation differential data for each provider. In this case a first-ranked service provider may on average be 10% cheaper than expectations and another may be 5% more expensive than expectations. Thus by measuring the historical outcomes vs. expectations, the pool of historical performance data able to be called upon to compare service providers is broadened as it is no longer constrained by the type of jobs performed in the past. Thus, in the illustrative example, using historical expectation differential data allows more suppliers to be considered for a job, even those who have only performed surveillance investigation jobs in the past.

As noted above by using a value that is compared to an expectation for allocating a job, dissimilar jobs performed by different service providers can be compared. For example, if a first service provider continually performs short term jobs with an average duration of one week and average cost of $1000, and another service provider typically performs jobs spanning a number of months and costing tens of thousands of dollars, the performance of these two service providers can not readily be compared in absolute terms. However they can be compared based on how well they have met the expectation of their buyers.

In the specification and claims the term “services” should be understood to extend to services that include the provision of associated goods or spare parts as a sub-component of the service. It also extends to the provision of goods where qualitative measures are also relevant. Qualitative measures that are relevant when the primary supplier deliverable is goods include: delivery time, time to despatch the order, percentage of goods that are damaged on arrival, quality of goods received.

It will be understood that the invention disclosed and defined herein extends to all alternative combinations of two or more of the individual features mentioned or evident from the text or drawings. All of these different combinations constitute various alternative aspects of the invention.

### BRIEF DESCRIPTION OF THE DRAWINGS

Notwithstanding any other forms which may fall within the scope of the present invention, preferred forms of the invention will now be described, by way of non-limiting example only, with reference to the accompanying drawings, in which:

FIG. 1 depicts a service provider selection system that can be used to implement a service monitoring method in accordance with an embodiment of the present invention.

FIG. 2 shows a flow-chart illustrating an overview of method according to a first embodiment of the present invention;

FIG. 2A shows a flowchart representing the operation of the method according to the embodiment of FIG. 2 which allows measurement of service provider performance against expectations;

FIG. 2B shows the sub-process used for setting expectation values in the process of FIG. 2A;

FIG. 2C shows the sub-process used for varying expectations once a job has begun;

FIG. 3 shows an exemplary spreadsheet including a set of historical expectation differential data for three service providers, and the results of a series of intermediate processing steps using expectation differential data to derive comparable performance indicators for each of the service providers;

FIG. 4A depicts a portion of a webpage interface used by a service provider when requesting a variation to a current expectation;

FIG. 4B depicts a portion of a webpage interface used by a service buyer when accepting or rejecting a requested variation to current expectation; and

FIG. 4C depicts a portion of a webpage interface used by a service buyer to input expectation data relating to qualitative factors of a job.

### DETAILED DESCRIPTION OF THE EMBODIMENTS

The preferred embodiment may advantageously be applied to situations where a high number of transactions between a buyer and a group of sellers occur, thus providing a large amount of historical data on which to base predictions of expectation differentials for the service providers. However the present invention should not be construed to be limited to a market of this type.

Preferably in using the system and method as described the service providers are aware that their performance will be compared with that of other service providers, thereby fostering competition within the marketplace. Accordingly the system and method described may provide means for trading in services of relatively low value which has the benefits of a tender system without requiring service providers to tender on a job-by-job basis.

The system described in PCT/AU03/00636 is particularly suited for selecting providers to perform services and/or supply goods with an associated service, of a type which can be readily broken down into a number of identifiable and comparable service components or elements. Typically service elements will be tasks or features of the service for which service providers can allocate a discrete fee, and which the procurer of the service can readily use to define the scope or quality of the service desired. However as will be appreciated certain types of complex jobs are not able to be readily broken down into discrete components. Such jobs may be allocated to service providers using the preferred embodiments of the present invention by defining a single element for the job that represents the performance of the complex task, eg. providing a course of physiotherapy treatment to an injured person can be grouped together into a single element of a job where in fact physiotherapy includes the performance of many different tasks such as massage, exercise consultations etc.

In the preferred embodiment of the present invention, jobs may be allocated by a buyer on the basis of historical expectation differential data that includes expectation data or benchmark data against which the performance of a service provider has been measured. In this embodiment the outcome/cost/service level in respect of each job performed by a service provider is compared to an expectation value that has been set prior to the performance of the job (and possibly varied during the job). The deviation from expectations, (or level of compliance to these expectations) are used to allocate future work in much the same way as historical cost was used in our earlier PCT applications.

In the present example the expectation differential data is expressed in terms of the deviation between the expected performance and actual performance, with the results being displayed quantitatively in appropriate units, eg. cost variations are displayed as the variation between actual and expected costs, represented in dollar terms. Clearly the differential data can be expressed in a number of ways, eg, actual performance as a percentage of expected performance, expected performance as a percentage of actual performance or the differential value expressed as a percentage or fraction of either the actual performance or estimated performance. Other statistical measures may also be used.

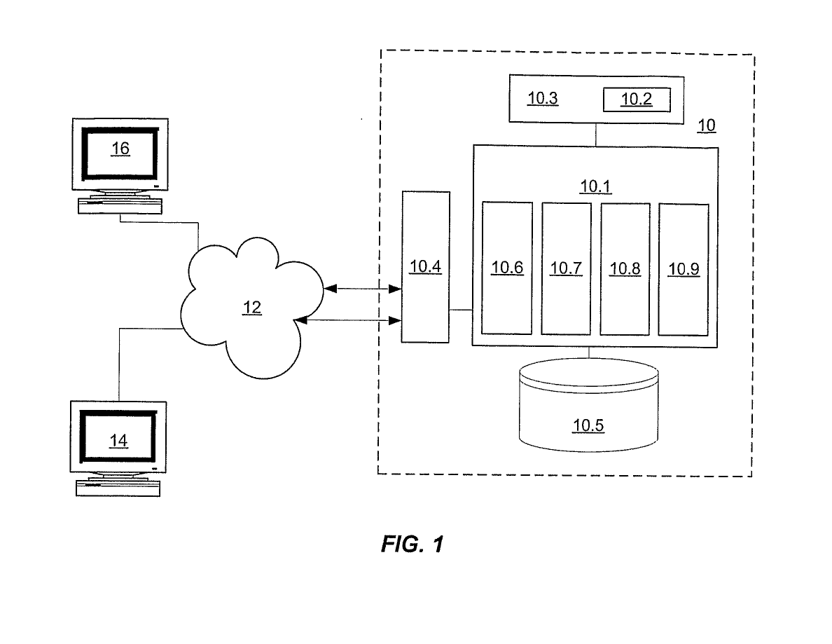

FIG. 1 depicts a service provider selection system that can be used to implement a service monitoring method in accordance with an embodiment of the present invention. The system 10 is effectively a service provider selection server and is in data communication via network 12 (which could be the Internet, an enterprise intranet, LAN, WAN, or other type, or combination of computer networks, whether wired or wireless) with one or more service providers 14 (only one shown for clarity) and one or more service buyers 16 (only one shown for clarity). The network 12 has been shown for clarity as a single network however as will be appreciated the service supplier 14 can connect to the system 10 via a different network to the service buyer 16, for example the supplier 14 may connect to the system 10 via the internet whereas the service buyer may communicate with the system 10 via a LAN. The service buyer 16 terminal can also be directly connected to, or integrated with the system 10.

The system 10 includes a processing device 10.1 and a memory 10.3. The processor operates under control of one or more software applications 10.2, which are stored in memory 10.3, to implement an embodiment of the methods described herein. The system 10 also includes an interface component 10.4 for receiving and sending data (such as job requests and expectation data) from and to the service providers 14 and service buyers 16.

Data (such as historical performance and expectation data etc.) that is needed in the operation of the system 10 is stored in data storage 10.5 in one or more database structures. As will be appreciated from the following description, the system 10 can be configured to interface with one or more external systems (not shown) and/or data sources (such as a best practice database) to obtain data necessary to implement the method.

The processor 10.1 is configured to control the following system components, to implement a service monitoring method in accordance with an embodiment of the present invention:

an expectation generation module 10.6 an expectation variation module 10.7;

a data capture module 10.8; and

service provider selection subsystem 10.9.

The operation of each of these modules will become apparent on reading the following description of an embodiment of the present invention.

An illustrative example of how the above system can be used is to be described in relation to the provision of rehabilitation service to a patient. However, it should be understood that this example is non-limiting and that the method described herein can be applied to the selection of suppliers of any service, with or without the provision of associated goods, and should not be construed as being limited to application to the provision of rehabilitation services.

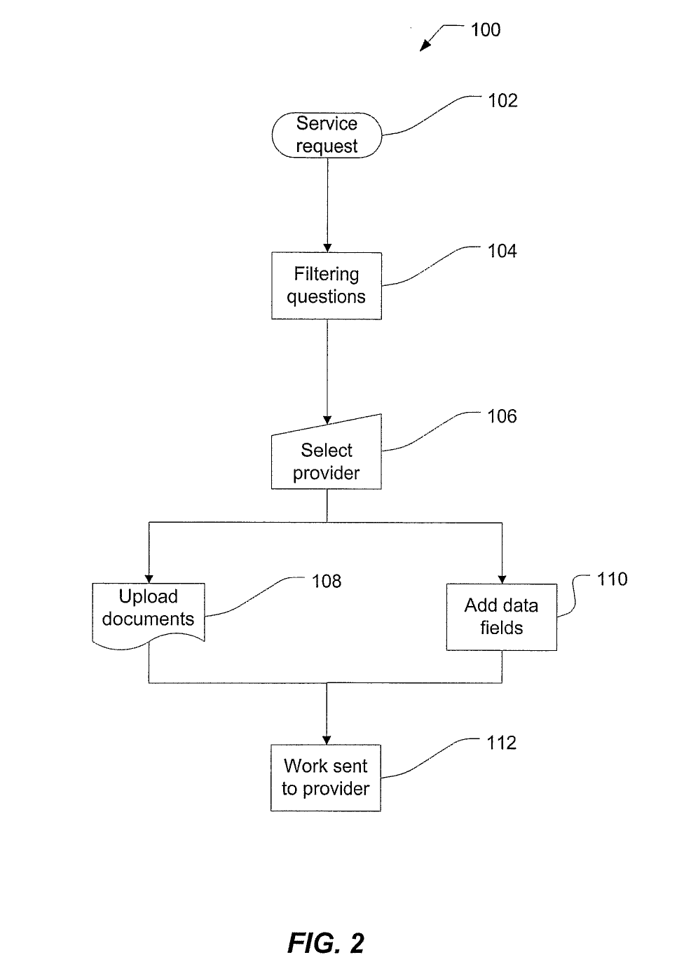

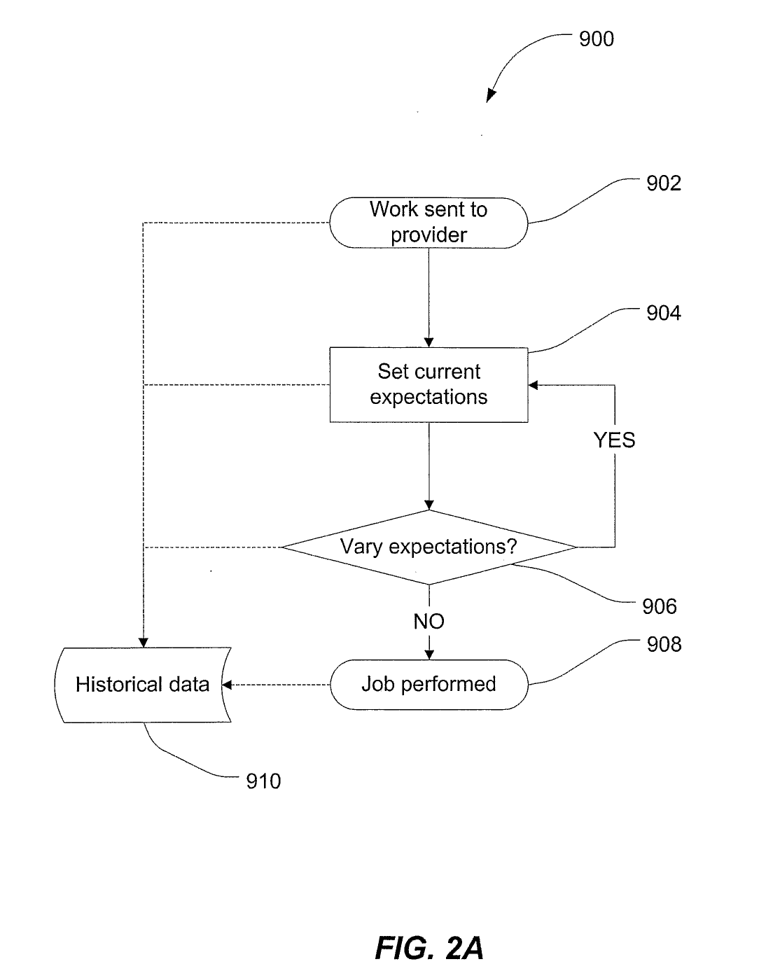

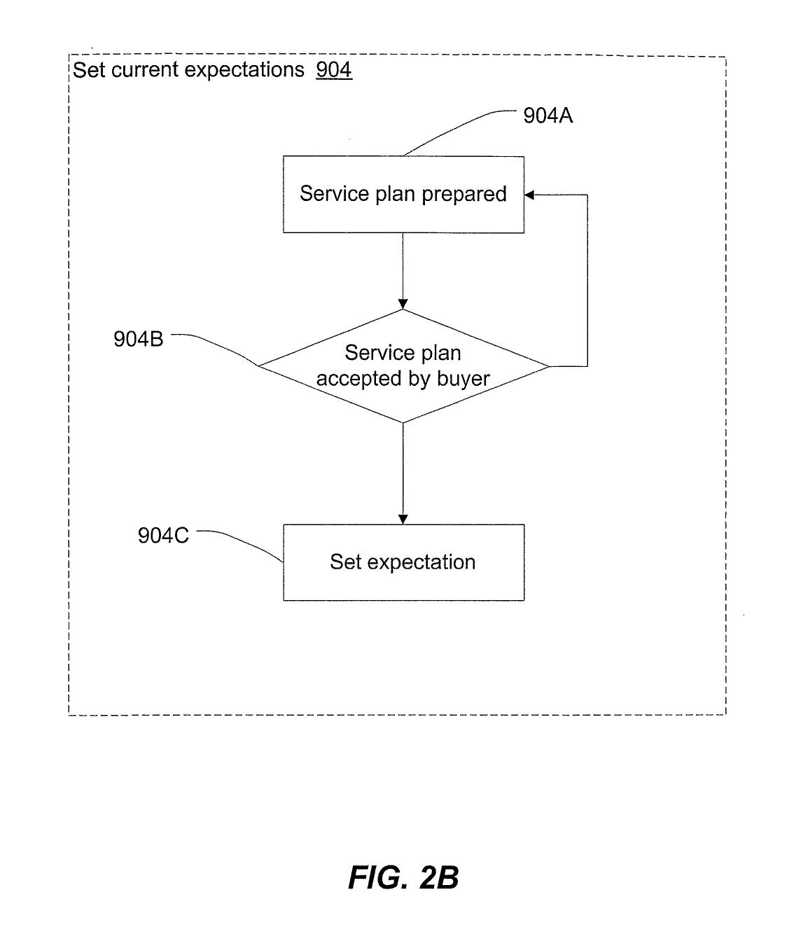

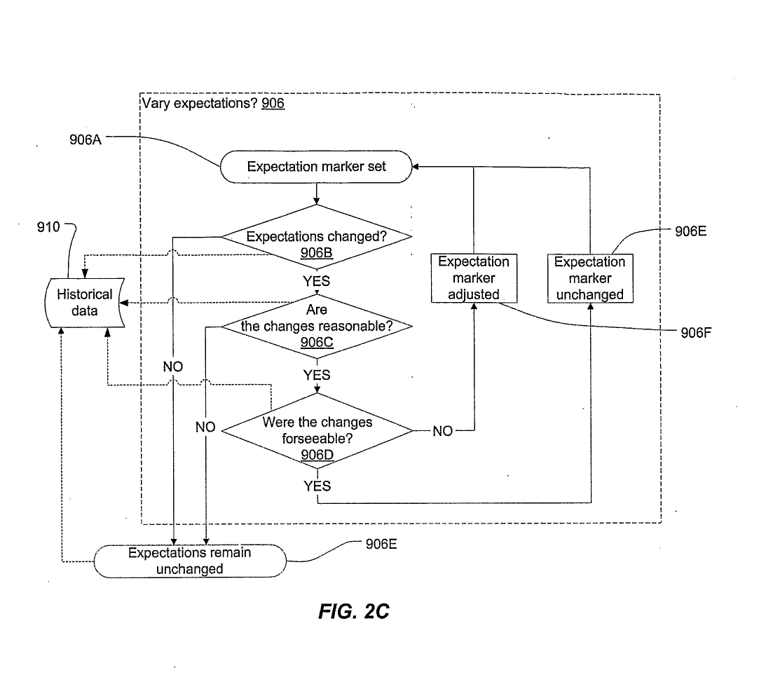

FIG. 2 shows a flowchart depicting an overview of a process for using deviation from expectations to compare service providers.

The process 100 begins at 102 by the input of a service request by the buyer which is received at the interface component 10.4 of the system 10. The service request defines the type of service that the buyer wants performed.

In the next step, 104, the buyer is given the opportunity to apply one or more filtering criteria using the service provider selection subsystem 10.9 to the request details in order to narrow the full list of potential service providers who can perform the requested job down to a group of providers who will be compared on their historical performance. The filtering information chosen by the buyer may also be used to narrow down the amount, or type, of historical data which can be used for the comparison of service providers.

The performance criteria describing the services can include attributes relating, inter alia, to:

the nature of the services;

specific attributes of the services; and

the quality or type of equipment and/or resources required to perform a service;

the qualifications or association memberships desired by people performing a service; and

other attributes of the service provider performing the job, which can affect the kind, quality or style of service performed, such as the length of time the supplier has been in business etc.

For example, when allocating a rehabilitation job to a rehabilitation service provider, one of the questions that may be asked is “What is the type of injury?”. If this is deemed by the buyer to be an important filtering question, then only service providers having historical data related to injuries of the same type will be considered as potential service providers in respect of the current job.

In a further embodiment, the filtering can be applied according to a predetermined set of criteria. For example, an insurer allocating rehabilitation jobs can specify a list of panel members that may be used in certain circumstances and from which a service provider must be selected, e.g. the buyer may have a predefined panel who can perform jobs for certain clients, or in certain geographical areas etc. This predefined filtering will typically be performed in combination with the case-by-case filtering described above, however it may also be performed without any case-specific filtering.

In the next step 106 the service provider selection subsystem 10.9 generates a list of one or more potential service providers and a comparable expectation differential indicator of their performance in respect of previous jobs which is presented to the service buyer.

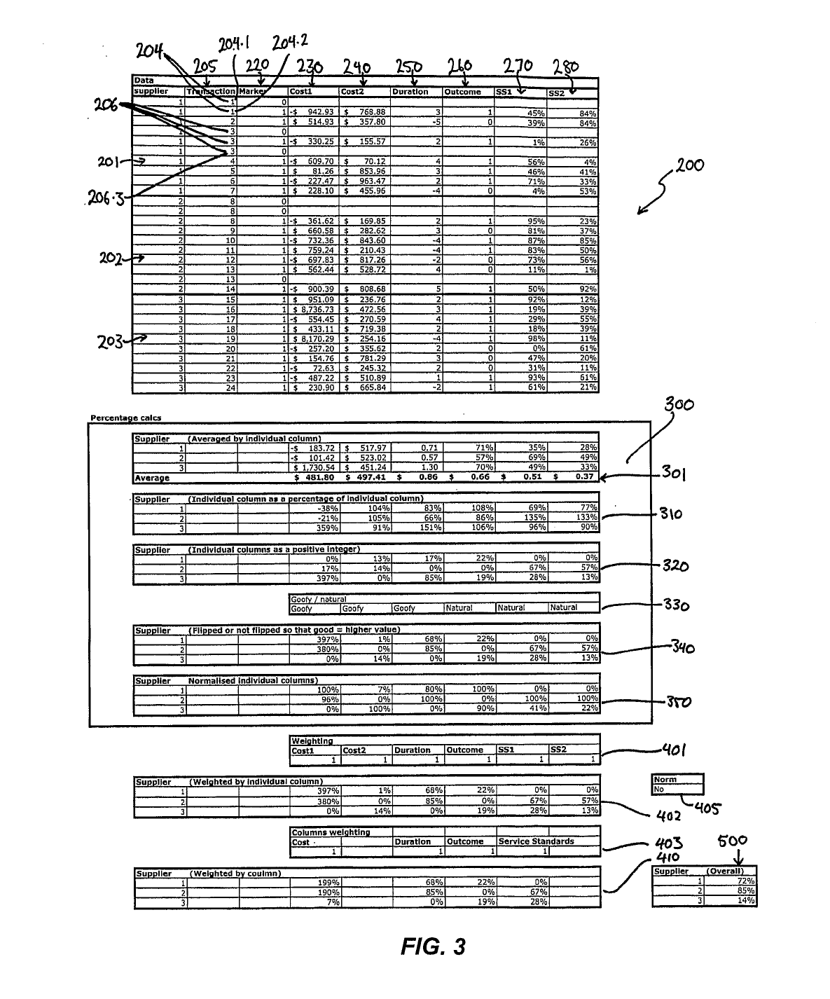

In step 106 the service provider selection subsystem 10.9 generates comparable performance criteria from historical expectation differential data as will be described in connection with FIG. 3. Rather than relying solely on absolute measures such as the cost of previous jobs or the quality of the service provided in previous jobs as the prior art has, the comparable data for each service provider is derived from measures representing the extent to which each of the potential service providers have met expectations on past jobs. In relation to a rehabilitation job, expectations may be comprised of a “Return to work goal” i.e. whether the patient will return to the same job with the same employer, or a different job with the same employer or the like. Expected costs and expected duration of previous jobs may also be important expectation criteria for allocating a job.

Next at 108 and 110, after a service provider is selected in step 106 the more detailed information relating to the job to be performed is uploaded 108 and any additional data to be measured is specified 110 and sent to the service provider chosen in step 106. Step 110 can be viewed as setting a preliminary set of performance expectations for the job, which may later be refined into an agreed set of performance expectations as described below in connection with FIG. 2A. The job is then handed over to the service provider at 112 for completion.

When a new job is allocated to a supplier and performance is to be measured against expectations it is necessary to set initial expectation values for those aspects of the service for which performance against expectations will be measured. Moreover during the performance of the job it may become necessary to vary the previously set expectations. FIG. 2A depicts a sub-process for setting (using the expectation generation module 10.6) and optionally varying performance expectations (using the expectation variation module 10.7), and storing expectation data as historical data in the data storage 10.5.

In an initial step 902, the job is allocated to a service provider and all relevant documentation is provided to the service provider to enable the job to be performed. In the next step 904, the expectation generation module 10.6 sets expectations for the performance of the job. The expectations can be set by any combination of the buyer, the service provider, or one or more third parties. For example in relation to a rehabilitation job, the opinion of an independent doctor may be used when setting expectations, or the employer of the person being rehabilitated may also have a say in setting the expectation level. In certain circumstances, as will be described below, historical data gathered over the performance of previous similar jobs may also be used to set the current expectation level in step 904.

In general, expectations can be set in a number of ways, including but not limited to:

1. As a default value by the service buyer.

2. By the service buyer on the basis of “best practice” data.

3. By the service buyer on the basis of previous (historical) performance.

4. By the service supplier allocated the job, after being awarded the job.

5. On the basis of quotations by multiple suppliers.

Each of these mechanisms for setting expectations is described more fully below, with examples of how each can be implemented.

1. As a Default Value by the Buyer

For any particular type of job being allocated, a buyer can set a default expectation for any aspect of the service or performance measure. Service buyers will normally set this default value aggressively, so that the supplier receiving the work has to perform efficiently to meet expectations. In this case it is likely that the service provider will have to request an expectation change. For example, an insurer allocating investigation jobs to investigation firms has determined that performance against expectations on cost and job duration measures are important. These measures are included in the allocation algorithm for awarding investigation jobs. The buyer determines that an expectation for cost on the particular job is $1000, and the initial expectation for duration is 30 days. These values are used as defaults to pre-populate the initial expectations on these measures for all jobs, or all jobs of a particular type.

2. By the Service Buyer on the Basis of “Best Practice” Data.

Some service buyers have access to databases that describe the best practice outcomes for a particular job type. In this situation the best practice database can be interrogated and the best practice data used to populate the expectations for a new job.

An example of this may arise when a general medical practitioner allocates jobs (e.g. patient referrals) to medical specialists. In this example the patient has a suspected kidney stone that needs to be removed by a surgical procedure. In the event that the local health authority has a database which stores the best practice outcomes for this type of clinical problem, such as the expected number of days off work following an operation, the number of days in hospital etc. the job allocation system can interrogate the best practice database, and populate the expectations for the referral (job) with this best practice data.

3. By the Service Buyer on the Basis of Previous (Historical) Performance.

Often, a buyer will allocate a significant number of jobs of the same general type, and will, over time, collect a substantial amount of data relating to supplier performance against numerous performance measures. This database can be interrogated and a business rule used to populate expectations for new jobs that have similar characteristics to those stored in the database. An example of such a database and method for compilation is described in our above mentioned international patent application PCT/AU03/00636.

An example of this situation may arise where an insurance division writing professional liability insurance has managed thousands of claims over time. Each claim is referred to a legal firm that manages the matter through to settlement. In the example there may be 10 clearly identifiable types of claim, and data has been collected relating to the cost, duration and outcome (in terms of settlement costs paid) for each matter across each claim category. When a new claim is received and the matter is referred to a legal firm, the initial expectations can then be set based on the previous performances (across all suppliers), on each measure, for the relevant claim type. For example the expectations could be set at the 80^{th} percentile of previous performances.

4. By the Service Supplier Allocated the Job, After Being Awarded the Job.

Sometimes, it is extremely difficult to set realistic expectations for a new job. This would be the case where there is significant variability between jobs, where the buyer has little information about the scope of the work that is required, or where the supplier is in a better position to assess the scope of the job compared to the buyer. In these cases, it is often more appropriate for the supplier to set the initial expectations for a job (for review by the buyer).

For example an insurer may allocate jobs to building firms to complete repairs to damaged property. Prior to allocation, the insurer has very little detail regarding the extent of damage and therefore the scope of the work to be allocated. In this case the builder awarded the job is authorized to inspect the property, and submit their assessment of the initial expectations for the job on measures that are important to the buyer (e.g. total expected cost and duration). These expectations, set by the builder, and accepted or rejected by the buyer, form the initial expectations for cost and duration for the job. Subsequently, the builder can request expectation changes to these measures as appropriate (e.g. they pull down a wall and discover substantial additional damage that was not initially visible). A more detailed example of this type of expectation setting and variation is described below in connection with rehabilitation services.

5. On the Basis of Quotations by Multiple Suppliers.

Many buyers use a quote system in which multiple suppliers review a job and submit their quote to the buyer. In this case, data within each quote can be utilised to set the initial expectations for the job by each supplier. For example a motor insurer receives a claim from a client following a motor vehicle accident. The insurer's policy is to ask the claimant to take the vehicle to three repairers where the damage will be assessed and the repairers will submit a quotation directly to the insurer. The quotations contain data (such as expected cost, total duration and number of days before work can begin) that can be used to populate the initial job expectations. The data within the quote of the supplier selected to carry out the work forms the initial expectations on these measures.

From time-to-time a review of expectation levels may be made, or it may be discovered during the conduct of a job, that the performance expectations set in step 904 are not going to be met. This may occur because the service provider is not performing up to the expected standard or the performance expectations are inappropriate. If it is found that the performance expectations are inappropriate it may be necessary to revise or vary the expectations to allow accurate performance appraisal of the service provider to be performed. The expectation variation module 10.7 enables the performance expectations set at 904 to be varied in step 906. If the change(s) in expectations are deemed to be acceptable and are ultimately changed, the process 900 loops back to expectation setting stage 904 and the job continues. If expectations are not changed, the job is completed at step 908. As will be appreciated the performance expectations in respect of a job may need to be varied more than once during the performance of a job.

Throughout the whole allocation process, the performance of the job, and after the completion of the job, job-related data that is generated can be stored as historical data in a database 910. The stored historical data can include data representing the expectation levels set, and any variations thereto as well as any information regarding the circumstances surrounding the variation in expectation levels which may be relevant to rating a particular service provider in the future. The actual performance data relating to the provision of a job can also be stored. Other historical data which can advantageously be stored will readily become apparent to those skilled in the art upon reading the more detailed description of the process which follows and by reference to the description and figures of PCT/AU03/00636, and in particular the database schema depicted in FIGS. 7A to 7E thereof.

FIG. 2B shows a more detailed view of the sub-process 904 for setting initial expectations. In an initial step 904A a service plan is prepared. The service plan may be prepared by the service provider, the buyer or a third party. As will be appreciated rehabilitation and other complex tasks may not readily be able to be broken in to service elements, and may require significant review or research by the selected service provider to enable an initial expectation level to be proposed. Thus, it will typically be necessary for either the service provider (or another person familiar with the job requirements) to provide a plan or proposal for the provision of service in order to allow a set of one or more performance expectations to be discussed and agreed upon by the service provider and buyer.

In the next step 904B the service plan can be amended if the service plan is not accepted by the buyer. Typically the buyer reviews the service plan and is able to either accept the service plan, suggest amendments or refer it back to the service provider for amendment. If necessary, third parties may be asked for advice in order for the service provider and the buyer to come to agreement on a service plan in which both of them are confident is reasonably attainable. Once the expectations are agreed to by the buyer, an Expectation Marker is set in step 904C.

In some embodiments a certainty rating can be given to an expectation that is set. This can later be used to weight the expectation differential data values to account for this uncertainty.

Once an expectation has been set, the service provider can begin to provide the service or perform the job with an understanding of the standard to which their performance will be compared and that this comparison against expectations will be used to allocate future work.

During the conduct of the job it may become necessary for the expectations to be changed to take into account a new situation. For example in rehabilitation work, a patient may not be progressing as required for a wide range of reasons. For example a worker's injury may be found to be more debilitating than initial assessments indicated, or the worker may fail to comply with recommended medical treatments. Such factors may change the expected duration and cost of the rehabilitation process through no fault of the provider. In such a situation the service provider will be unable to meet the expectation, and thus without some means for adjusting expectations, they would be unfairly disadvantaged in the allocation of future work because they have not met expectations. In other cases, a service provider might request adjustments to the time and cost estimates to account for a contingency that the case manager feels could reasonably have been foreseen when the initial rehabilitation plan was drawn up. In such instances, even though the additional treatment might be approved, measuring the final outcomes against the revised expectations would not reflect this concern. The process described in FIG. 2C shows how changes in expectations can be managed.

The process for changing expectations 906 begins with a stage of setting and date stamping expectations 906A. If during the performance of the job expectations change 906B the buyer or the service provider may approach the other party to vary expectations. If the expectations have not truly changed, then the answer to the question “Expectations changed?” is “No” and the expectations remain unchanged 906E and the service provider's expectation differential is judged against the previously approved performance expectations.

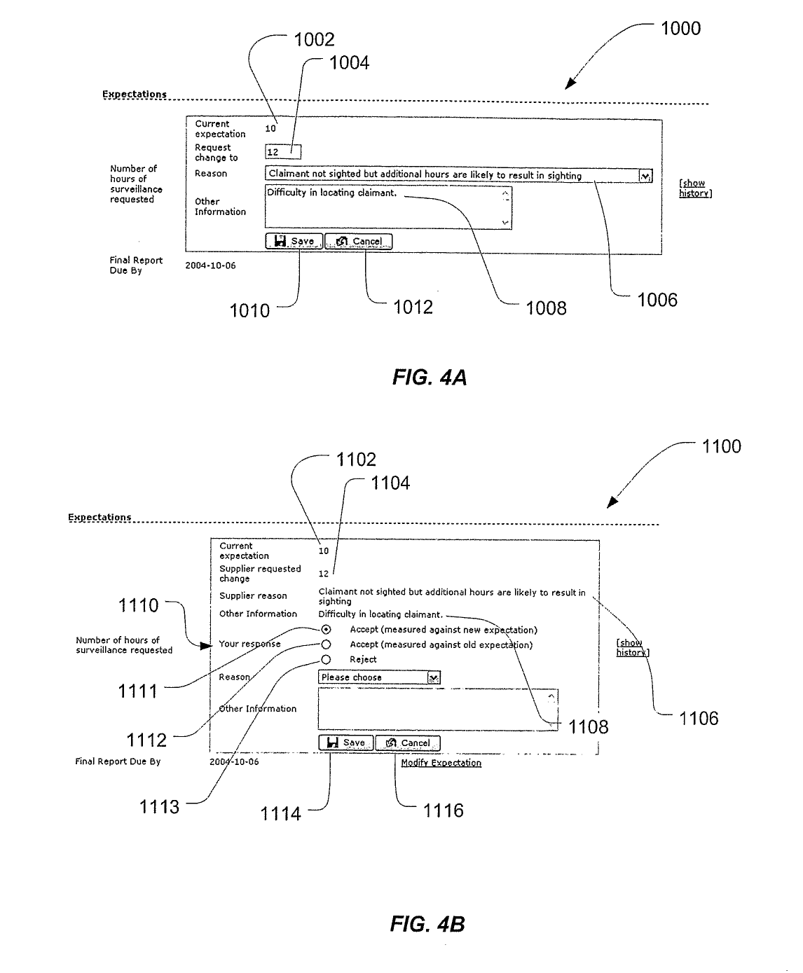

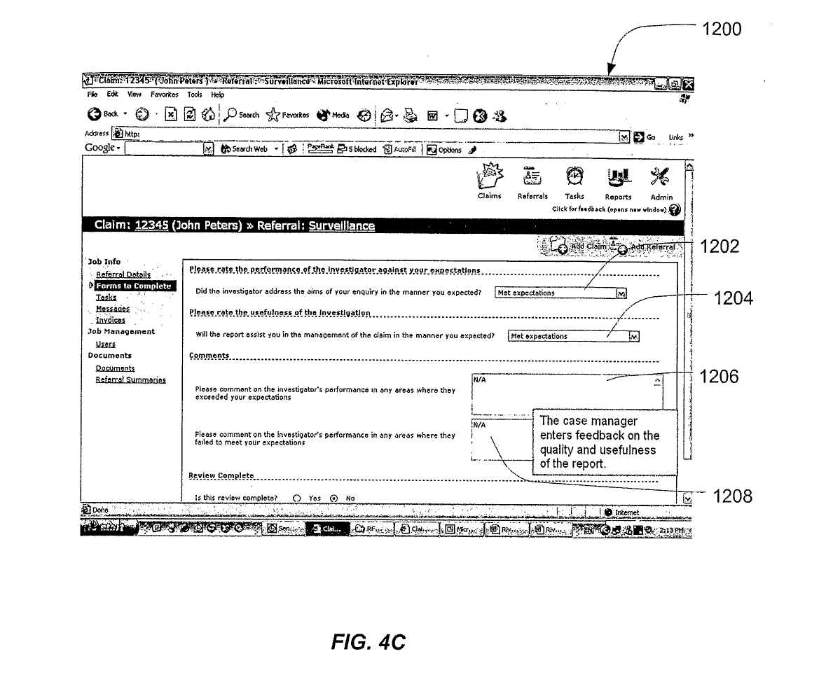

FIG. 4A depicts an portion of a webpage interface that can be used by a service provider to request a change in job expectations. The interface 1000 includes a display of the current expectations 1002 and a display of the requested (i.e. revised) expectations 1004. The service provider can add reason for request for an expectation adjustment as indicated at, using either or both of the drop down menu 1006 or the “Other information” text box 1008. In the present example the service being performed is an investigation that includes a surveillance component, and the investigator is requesting a change of expectations because he or she can't find he subject of the investigation. On selecting the save button 1010 the request in sent to the service buyer for consideration an possible acceptance. Selecting the cancel button 1012 cancels the request for revision of the expectation value.

If on the other hand, if expectations have truly changed, the process moves to step 906C in which the question is asked “Are the changes reasonable?”

As will be appreciated, a change in expectations will usually be initiated by the service provider and accordingly the question of whether changes are reasonable will typically be determined by the buyer. FIG. 4B depicts an portion of a webpage interface that can be used by a service buyer to either accept or reject a request for a change in job expectations. The interface 1100 includes a display of the current expectations 1102 and a display of the requested (i.e. revised) expectations 1104. The service buyer is also presented with the service provider's reason for requesting the expectation adjustment as indicated at 1106 and/or 1108.

The service buyer can accept or reject the service provider's request by selecting the appropriate response button at 1110. The effect of selection each of the three buttons, namely:

Accept (measured against new expectation) 1111;

Accept (measured against old expectation) 1112; and

Reject 1113;

will be explained more fully below.

Once the service buyer has chosen whether to select of reject the request, he or she can either save their decision by clicking the save button 1114. Selecting the cancel button 1116 cancels their revision of the expectation value.

For example, it may be reasonable to expect that an additional two weeks is needed to fully rehabilitate the patient if the current treatment is less effective than expected. In such a case, the change in expectations is reasonable. In this case the service buyer, using the interface of FIG. 4B would select Accept (measured against new expectation) 1111 as his or her choice of response. If a change is deemed not to be reasonable in step 906, expectations remain unchanged 906E and the job continues as previously indicated and the service provider's expectation differential is judged against the previously approved performance expectations. In this case the service buyer, using the interface of FIG. 4B would select Reject 1113 as his or her choice of response.

If the changes are deemed to be reasonable at 906C the next question to be asked is “Were the changes foreseeable?” at 906D. In either case as the changes have been deemed to be reasonable, the additional time or charges or other changing situation will be approved by the buyer. This typically means that the service buyer will not refuse to accept the additional charges or job duration or the fact that some other performance criterion cannot be met. However the service provider will not be given the advantage of having their performance compared to an updated performance expectation as will be seen below. In this case the service buyer, using the interface of FIG. 4B would select Accept (measured against old expectation) 1112 as his or her choice of response.

If it is found that the reason the expectation that was set for this aspect of the job was initially underestimated because the service provider has failed to take into account some relevant and known factor when assessing job then the change is deemed to be foreseeable. On the other hand, if the service provider could not have known about the cause of the expectation adjustment, e.g. the service provider receives a new medical report indicating that a patient's condition is more serious than originally believed, a change in expectations may be deemed to be unforeseeable. As indicated at 906E and 906F these two situations are handled differently. In a case in which an unforeseeable situation causes expectations to be varied, then the expectation marker, that is used to set the current expectation level is moved so that the newly set performance expectation becomes the current valid expectation. In the case in which a foreseeable variation of the expectations is requested then the expectation marker is not changed. In this case the most recent performance expectation having an expectation marker is used to assess the performance of the service provider rather than the newly requested expectation. As described in connection with FIG. 3 below, jobs carrying an expectation marker value of “1” in the “Marker” field have a valid expectation marker set corresponding to that entry, whereas an expectation marker value of “0” in the “Marker” indicates that the expectation marker is set at another expectation for that job.

If the buyer believes that the expectation change requested by the supplier is excessive, but has some merit, then they can optionally set an expectation marker at a value between the last agreed level and the new level requested by the supplier. In this case the expectation marker is set at the intermediate expectation level chosen by the buyer. The higher expectation level that was requested by the service supplier may be stored as expectation data but will not have an expectation marker set for it.

For any given job more than one change to expectations may be necessary. In this situation it is possible for the service provider to be judged against a combination of their original expectation and any accepted and unforeseeable changes of expectation which occurred during the conduct of the job. For example, if a job is originally expected to cost $3,000 and due to circumstances arising the service provider then believes the job will cost $3,400 the service provider may request the expectation to be changed by the buyer. However if the buyer thinks that this change in expectation was foreseeable, the expectation marker is unchanged and the performance of the service provider will still be measured against the initial expectation of $3,000. If a subsequent change of expectations occurs and the job becomes more complicated and the service provider then believes that the job will cost $3,900 which represents a further increase of $500. If the buyer agrees that the second change was not foreseeable and that the additional $500 expense is reasonable, the expectations can be upgraded to account for this incremental increase in expectations. Thus, the expectation increases by $500 from $3,000 to $3,500. In this case the expectation marker is set in line with the newly approved and unforeseeable expectations. Thus in this case the service provider's cost performance will be compared to a value of $3,500 (original cost+extra reasonable, unforeseen cost), rather than to the total cost $3,900 that the service provider has been requested.

It should be noted that some types of expectations (e.g. whether an outcome has been met) are not incremental (like cost) but binary, that is, they are either achieved or they are not achieved. In this instance the performance expectations are governed by the position of the expectation marker rather than being the sum of the original expectations and the subsequent unforeseen expectation adjustments.

Some expectation values may be qualitative, such as a buyer's expectation relating to the form of a report or the usefulness of evidence supplied in an investigation. Whether or not a service provider meets these expectations is typically determined by the service buyer after the completion of the job. FIG. 4C depicts a portion of an exemplary webpage interface used by a service buyer to input expectation outcomes relating to qualitative factors of a job. As can be seen the interface 1200 allows a service buyer to select (at 1202 and 1204 respectively) the extent to which an investigator met the expectations of the buyer in addressing aims of a job, and the extent to which a report provided meets expectations. The service buyer uses the drop down menus to select whether the service provider “Met expectations”. Alternatively he or she can indicate the service provider failed to meet expectations or exceeded expectations by selecting the appropriate menu choice. Other ways of indicating the level of buyer satisfaction e.g. using a numerical score could also be applied. Comments can also be added at 1206 and 1208.

In all steps of the process 906, the expectations and the situation surrounding changes and whether the changes are foreseeable and reasonable as well as the outcomes of the job are stored as historical data in the historical data database 910.

As described above the expectation data collected in this way by the data capture component 10.8 and updated in accordance with this method can be used to obtain reasonable expectation values against which the service provider's performance can be compared. An allocation algorithm 10.9 similar to that described in PCT/AU03/00636 can be used to derive comparable expectation differential data for each service provider to enable a service provider to select the best service provider to perform the next job.

FIG. 3 shows part of a dataset 200 containing historical data for three service providers 201, 202 and 203 and is used to illustrate a method of calculating comparable expectation differential data for the service providers according to an embodiment of the present invention. Rows of data labelled with the same transaction number in column 205, eg 204, represent data relating to a single job requested by a buyer, and performed by the service provider.

The dataset 200 consists of nine columns of data 205 to 280 as will be described below. The columns of data contain the following data classes.

Column 210 “Data Supplier”

Column 210 include data signifying which service provider performed a particular job. The data in the table 200 is sorted according to data supplier, accordingly the first 10 rows of data all correspond to the historical performance of supplier number 1, and subsequent 10 rows of data correspond to supplier number 2 and so on for supplier number 3.

Column 205 “Transaction”

Column 205 contains a transaction number which is associated with each row of data in the data table 200. As will be noted more than one row can contain the same transaction number. The occurrence of more than one row having the same transaction column indicates that there has been a variation of the performance expectations used in the transaction.

Column 220 “Marker”

The expectation marker column includes an expectation marker which can take the value of either “0” or “1” to indicate where a performance expectation marker has been set for the particular transaction. The presence of value “0” in the marker cell indicates that the corresponding data row does not contain a valid performance expectation value. The presence of data value “1” in the marker column indicates that the performance expectation corresponds to that row containing the marker that is valid for a particular transaction. The presence of a “0” in the marker column can indicate either that a variation has been made to the performance expectation for the transaction and that the row is no longer the current expectation, or that a change to the performance expectation for the transaction was requested and rejected as being foreseeable (or otherwise not allowable) by the buyer. Using row 204 relating to transaction number 1 as an example, the presence of 0 in cell 204.1 indicates that an old performance expectation value has existed in this row and that this has been revised. The cell in the next row 204.2 contains the value 1 which indicates that the change has been applied to a previous performance expectation value and that it is now the accepted current performance expectation value for the transaction.

Transaction number 3 has data contained in the group of rows 206. In the marker column 220 the series of values 010 is entered. The initial two values 0 and 1 denote that the same situation has occurred as for transaction 1, that is an original performance expectation value has been superseded and replaced by a new, and currently valid performance expectation value. The presence of the following 0 (item 206.3) in the marker column 220 indicates that a subsequent request for variation of the performance expectation value has been made but that has been rejected. Thus in the situation the current performance expectation value which is valid is the row indicated by the reference numeral 1. As will be noted the subsequent columns in the table do not contain expectation differential values in rows in which the marker value is set to 0 as these rows of the dataset 200 do not correspond to a valid performance expectation. In a preferred implementation of the system, this data will be stored in the historical database, however, it will not be used in the analysis of the performance of the suppliers.

It is also possible that more than one expectations marker can be set for a particular transaction. The additional expectations markers indicate a benchmark expectation that can be used for a specific purpose, e.g. by an auditor or the like. For example a buyer may choose to change their policy concerning what changes are acceptable or considered foreseeable. Under the new policy regime the correct expectation marker position may differ from the position of the expectation markers set under the old policy. By retroactively setting additional expectation markers for past jobs according to the new policy the future work can be allocated according to the new policy by comparing actual performance against the second set of expectation markers.

Columns 230, 240, 250, 260, 270, 280 “Expectation Differential Value Columns”

The columns 230-280 contain data which represents the differential between the service providers' actual performance in respect of a particular job and the performance expectation, for a range of service criteria. In the present example there are two costs differential columns 230 and 240, a duration differential column 250, an outcome differential column 260 and two service standards differential columns 270 and 280.

As will be appreciated by those skilled in the art expectation differentials can be expressed in a variety of different ways depending upon the nature of the performance criterion being measured. For example, cost differentials 230, 240 are represented as monetary values representing the difference between the actual costs and the expected cost for either the whole or part of a job that has been performed. Duration differential is represented as a number of days, over or under the expected time for the past job. The outcome differential represents the deviation from expected outcome that occurred in respect of a particular job. This is a binary value indicating that the outcome has been achieved “1” or not achieved “0”.

The service standard expectation differential will typically represent the deviation from desired performance standards or protocol for previously performed jobs. The service standards values will typically be recorded on a subjective basis by the buyer in respect of each service, e.g. as a percentage value. In the present example a rating less than 50% is below expectation and a rating above 50% indicates that the provider has performed above expectations.

As will be appreciated many methods of calculating comparable expectation differential data for suppliers can be devised, such as single or multiple regression. In the present example a process of determining each service provider's percentage deviation from the average expectation differential (in respect of each performance criterion) is used. This is further processed to derive a single comparable expectation differential value (500).

Data in table 300 represents a combined expectation differential for each service provider in respect of each performance criteria. The value provided for each service provider in respect of each service criterion represents an average differential between their actual performance and their expected performance for all past jobs. A higher value indicates that the performance was above expectation, i.e. more expensive in terms of cost, or longer in terms of duration, or above expected standards in terms of outcome or service level. A lower value indicates below expected performance in each of these criterions.

Row 301 of table 300 represents the average expectation differential for each performance criterion across the three service providers, eg. the average cost differential for “cost 1” for all service providers is $481.80.

The differential of each service provider can then be represented as a percentage of this average differential figure. This data is shown in table 310.

In the next table 320 the percentage differentials are converted to a positive integer by subtracting the lowest percentage average value (for the corresponding criterion) from the percentage value for each service provider. Thus in each criterion the lowest value will always be 0.

The value assigned to each criterion in table 330 represents whether the calculated values for the criterion represent increased desirability with increased numerical value, or decreased desirability with increased numerical value. Values that increase with increased desirability are labelled as “natural” whereas values that decrease with increased desirability are labelled as “goofy”.

In the next table 340 all “goofy” values are flipped so as to become “natural” values to allow more intuitive comparison by the service buyers.

These final supplier differential ratings 340 can be used “as is” or normalised to a value between 0 and 100. Normalised values for the data are contained in table 350.

By selecting “No” in the Norm box 405 the non normalised data in table 340 is used to generate the weighted performance criterion contained in table 402. These values are generated by multiplying the values in table 340 by the corresponding weighting stored in weightings table 401. It will be noted that each of the performance criteria has been weighted with a value of 1 which indicates that they are all equally as important as each other, to the buyer. Clearly these weightings can deviate from 1 to indicate a greater or lesser importance level.

In the next block of data 403 a further set of weightings are represented. This second set of weightings 403 are used when combining the final cost, duration, outcome and service standard expectation differentials into a single comparable expectation differential measure for each service provider. In the next block of data 410 the expectation differentials for the two cost components are combined into a single cost differential value. As there is only a single duration measure, and a single outcome measure, no combination of these values is needed and the data shown in data group 402 simply migrates into data group 420 without change. As with cost there are two service standard components which are combined into a single service standard expectation differential value. As can be seen when judged on costs, supplier 1 is the most favourable, but when judged on duration and service standards, supplier 2 is superior.

The final data block 500 shows an overall expectation differential rating for each service provider. The expectation differential value for each expectation differential criteria is combined according to the weightings in data block 403 in order to generate the data 500. As can be seen supplier 2 has an overall rating of 85% making it the most favourable supplier to perform this job.

The number of past jobs which are included in the dataset may be varied to tailor the system to a particular application. For example, in some industries where price fluctuates quickly it may be necessary to only use a small sample of past jobs for determining cost effectiveness. Certain jobs or sales may even be removed from the sample set used, say the two most expensive and two least expensive jobs, or all jobs falling outside two standard deviations from the average.

It should be noted that a comparable desirability index can be generated by combining (possibly in a weighted fashion) the comparable expectation differential measure described above for each service provider with cost effectiveness and/or quality rating of the type described in PCT/AU00/00636.

As described in PCT/AU03/00636 the buyer of a service can specify relative weightings for each of the performance criteria or detail of a job if they wish to be presented with a comparable estimate for each of the service providers that accounts for their preferences.

In the preferred embodiment the comparable performance indicator 500 (and/or optionally some portion of the data generated, or used, in the derivation of the comparable performance criterion) for each service provider will be provided to the buyer to allow him or her to select a service provider. The data will typically be presented by way of a graphical user interface on a computer display. The computer displaying the results to the user can be configured to allow a user to display the results for a plurality of service providers simultaneously, or only one service provider at a time.

In addition comparative performance data may also be transmitted to each of the service providers. Typically the transmitted data will take the form of providing a set of rankings or a subset of the stored historical cost, quality and/or performance expectation data for all possible service providers (or a subset) to each service provider with all data, such as names, identifying the other service providers being hidden or removed. In this way individual service providers can view their relative ranking, or other data, without necessarily knowing the identities of their competitors. Such reporting to service providers can foster competition in the marketplace by showing each service provider what level of service, or cost of service, needs to be provided in order to increase their chance of winning more work.

It would be appreciated by a person skilled in the art that numerous variations and/or modifications may be made to the present invention as shown in the specific embodiments without departing from the spirit or scope of the invention as broadly described. For example, the present selection system for investigation services here described has been implemented on the Internet, but other network configurations could also be used to implement the present invention. The present embodiments are therefore, to be considered in all respects to be illustrative and not restrictive. Moreover the foregoing focuses on embodiments of the present invention that are used in an environment where there is more than one service provider competing for an individual job, such as in an open market situation or a situation where a buyer has a panel of service providers, and where the buyer(s) repeatedly purchase products or services from the sellers. However, the invention can easily be applied to circumstances where a single supplier contract is in place, and where that supplier repeatedly receives distinct new work allocations.

Buyers will often set up sole supplier agreements where only one supplier provides services or goods for the duration of the agreement. Normally, minimum performance standards are set within the contract, and the supplier receives all new referrals associated with the contract, until the term expires, so long as they continue to meet the minimum standards. Commonly, a single provider agreement for services incorporates repetitively allocating new work throughout the duration of the contract.

A significant issue with single supplier agreements is the impact of variations on supplier performance. For example, an IT company might have a single provider agreement for all IT related consulting services. Often, if the expected cost of any discreet job is likely to be above a designated threshold, the supplier will be asked to submit a quotation which must be approved before work can begin. In many cases, the outcome of the job will vary significantly compared to the original quotation. The invention provides a mechanism to allow the variance against the expectations set in the initial quote to be managed using the mechanisms for the supplier to request expectation changes to be approved described within this document. Advantageously an embodiment of the present system and method can be used to take changing job-specific circumstances into account when monitoring the performance of the service provider.

1. A computerised method of enabling the selection of a service provider for performing a service, said method including:
(a) processing a service enquiry for a particular service;
(b) retrieving historical expectation differential data associated with said service in respect of a plurality of service providers in response to said service enquiry;
(c) processing said historical expectation differential data, to arrive at comparable expectation differential data in respect of said plurality of service providers for enabling the selection of a service provider to perform the particular service;
(d) capturing expectation differential data relating to the provision of the particular service by the selected service provider, and
(e) updating the historical expectation differential data by incorporating said captured expectation differential data.

2. A computerised method as claimed in claim 1 which includes repeating steps (a) to (e) to enable the selection of a service provider for the provision of subsequent services with the aid of updated expectation differential data.

3. A computerised method as claimed in claim 1 which includes compiling an expectation differential dataset including historical expectation differential data components associated with the provision of at least one previous service by each service provider.

4. A computerised method as claimed in claim 1 which further includes defining at least one performance expectation for the performance of the service, and monitoring this against actual performance.

5. A computerised method as claimed in claim 1 wherein the expectation differential data includes data derived from both performance expectation data and actual performance data.

6. A computerised method as claimed in claim 5 that includes;
processing said captured actual performance data and said performance expectation data to generate data indicative of the differential between the actual performance of past services and a corresponding performance expectation; and
updating the historical expectation differential data by incorporating said processed differential performance data.

7. A computerised method as claimed in claim 1 that includes:
retrieving historical performance data relating to the actual performance of past jobs and associated performance expectation data for the past jobs in respect of a plurality of service providers in response to said service enquiry;
processing said data related to the actual performance of past jobs and corresponding performance expectation data to generate data indicative of the differential between the actual performance of past services and a corresponding performance expectation.

8. A computerised method as claimed in claim 1 wherein the historical expectation differential data includes performance data relating to at least one of the following:
the cost of past services; the quality of past services, with the quality of past services including the timeliness of the provision of past services; the duration of past services; and the outcome of the past services.

9. A computerised method as claimed in claim 1 wherein the comparable expectation differential data in respect of each of the service providers is combined with at least one of comparable cost data, and comparable quality data, to derive a comparable performance index for each service provider for enabling the selection of a service provider to perform the particular service.

10. A computerised method as claimed in claim 5 wherein at least one performance expectation for the performance of the service is set at least in part by one or more of the following: a buyer, a chosen service provider, a third party.

11. A computerised method as claimed in claim 5 which includes:
enabling at least one performance expectation for the service to be varied; and
capturing as historical expectation differential data, data relating to a variation in at least one performance expectation for the service.

12. A computerised method according to claim 11 including enabling a procurer of the service to approve or deny variation to a performance expectation, or to accept a new expectation that is between the last agreed expectation and the requested expectation.

13. A computerised method according to claim 12 in which the procurer can deny variation to a performance expectation if the variation was foreseeable when an initial performance expectation was set.

14. A computerised method according to claim 11 in which expectation differential data is measured relative to a combination of the initial performance expectation value and one or more subsequent incremental changes to the performance expectation that were not foreseeable when the initial performance expectation was set.

15. A computerised method according to claim 4 wherein defining at least one performance expectation for the performance of the service is performed on the basis of at least one of the following:
a default performance expectation
best practice data;
the actual historical performance of one or more service providers;
a service plan proposed by the service supplier; and
one or more quotations provides respective service providers.

16. A computerised method according to claim 15 wherein defining at least one performance expectation for the performance of the service includes:
receiving a service plan from a chosen service provider, and
setting at least one performance expectation for the performance of the service in accordance with the service plan if a procurer approves the service plan.

17. A computerised method according to claim 9 wherein the combination of the comparable cost data and comparable quality data and comparable expectation differential data is performed in accordance with weightings reflecting the relative importance of the comparable cost data, comparable quality data and comparable expectation differential data to the buyer.

18. A computerised method of enabling the selection of a service provider for performing a service, said method including:
(a) compiling historical actual performance data and corresponding performance expectation data associated with the provision of at least one previous service by a plurality of service providers;
(b) processing said actual performance data and performance expectation data to arrive at comparable expectation differential data in respect of said service providers for enabling the selection of a service provider to perform the particular service;
(c) capturing actual performance data and performance expectation data relating to the provision of the particular service by the selected service provider; and
(d) updating the historical actual performance data and performance expectation data to incorporate said captured actual performance data and performance expectation data.

19. A computerised method as claimed in claim 18 which includes setting an initial performance expectation.

20. A computerised method as claimed in claim 18 in which a performance expectation is set on the basis of at least one of the following:
a default performance expectation;
best practice data;
the actual historical performance of one or more service providers;
a service plan proposed by the service supplier; and
one or more quotations provided by respective service providers.

21. A computerised method as claimed in claim 18 which includes enabling variation of the performance expectation during the performance of the job.

22. A computerised method as claimed in claim 21 in which a variation of the performance expectation during the performance is allowable when the variation was not foreseeable when the initial performance expectation was set.

23. A computerised method as claimed in claim 21 in which the performance expectation data used to arrive at comparable expectation differential data is derived from the initial performance expectation and one or more subsequent non-foreseeable variations to the performance expectation data.

24. A computerised method of enabling a comparison of a performance of a service provider performing a service against at least one performance expectation, said method including:
(a) setting at least one initial performance expectation in relation to the service;
(b) capturing at least one amended performance expectation in relation to the service, in the event that at least one expectation variation criterion is met;
(c) determining at least one current performance expectation in relation to the service on the basis of one or more of, an initial performance expectation and one or more corresponding amended performance expectations on the basis of the expectation variation criterion that was met at the time the amended performance expectation was captured;
(d) capturing actual performance data relating to the provision of the service by the service provider; and
(e) comparing the actual performance data against at least one current performance expectation.

25. A computerised method as claimed in claim 24 in which a performance expectation is set on the basis of at least one of the following:
a default performance expectation;
best practice data;
the actual historical performance of one or more service providers;
a service plan proposed by the service supplier; and
one or more quotations provided by respective service providers.

26. A computerised method as claimed in claim 25 in which an expectation variation criterion is based on at least one of the following:
the extent to which the variation to the initial performance expectation was foreseeable when the current performance expectation was set; and
the extent to which the variation to the initial performance expectation is reasonable.

27. A computerised method as claimed in claim 24 in which the current performance expectation is derived from the initial performance expectation and at least one subsequent, non-foreseeable amended performance expectation.

28. A computerised method as claimed in claim 24 which includes storing at least one of the following in a historical performance database:
at least one initial performance expectation;
at least one amended performance expectation;
expectation variation criterion data;
at least one current performance expectation; and
actual performance data.

29. A computer-readable medium having stored thereon executable instructions for causing a computer to perform a method of claim 1.

30. A computer system to enable a buyer to select a service provider for performing a service, said system including:
an enquiry processing component configured to receive and process a service enquiry for a particular service from the buyer;
a database configured to store historical expectation differential data associated with said service in respect of a plurality of service providers; and
a processor configured to retrieve and process said historical expectation differential data from said database in response to said query to arrive at comparable expectation differential data in respect of said service providers for enabling the buyer to select a service provider, on the basis of said comparable expectation differential data, to perform the particular service.

31. A computer system as claimed in claim 30 which includes:
a data capture component configured to capture actual performance data, and performance expectation data, relating to the provision of the particular service by the selected service provider, and an updating component to update the historical expectation differential data on the database with said captured performance data.

32. A computer system as claimed in claim 30 in which the system further includes:
an expectation variation component configured to enable variation of performance expectation data associated with a service.

33. A computer system as claimed in claim 30 wherein the processor is configured to derive a comparable performance index for each service provider by combining the comparable expectation differential data, comparable cost data and comparable quality data in respect of each of the service providers, with the combination of the comparable expectation differential data, the comparable cost data and comparable quality data being performed in accordance with weightings reflecting the relative importance of the comparable expectation differential data, the comparable cost data and comparable quality data to the buyer.

34. A computer system as claimed in claim 33 wherein the data capture component is further configured to capture varied performance expectation data relating to the provision of the particular service by the selected service provider.

35. A computer system as claimed in claim 30 which further includes a performance expectation generation component configured to generate performance expectation data in relation to the particular service.

36. A computer system as claimed in claim 35 wherein the performance expectation generation component is configured to generate performance expectation data on the basis of at least one or more of the following:
a default performance expectation;
best practice data;
the actual historical performance of one or more service providers;
a service plan proposed by the service supplier; and
at least one quotation provided by respective service providers.

37. A computer operating under the control of the computer readable medium of claim 29.

38. A computerised method of enabling a comparison of a performance of a service provider performing a service against at least one performance expectation, said method including:
(a) setting at least one initial performance expectation in relation to the service;
(b) receiving a request to amend the initial performance expectation in relation to the service;
(c) processing the request by either accepting, rejecting or modifying the received request;
(d) determining at least one current performance expectation in relation to the service on the basis of at least one initial performance expectation and the processed request; and
(e) comparing the performance of the service provider in relation to service to the at least one current performance expectation.

39. A computerised method as claimed in claim 38 in which the initial performance expectation is set on the basis of at least one of the following:
a default performance expectation;
best practice data;
the actual historical performance of one or more service providers;
a service plan proposed by the service supplier; and
at least one or more quotation provided by respective service providers.

40. A computerised method as claimed in claim 38 which includes storing at least one of the following in a historical performance database:
at least one initial performance expectation;
a request to amend a performance expectation;
at least one current performance expectation; and
actual performance data.

41. (canceled)
